(19) United States
(12) Patent Application Publication
(10) Pub. No.: US 2009/0022909 A1
(43) Pub. Date: Jan. 22, 2009

(54) Adhesion composition, making method of adhesion composition, display device and making method of display device

(75) Inventors: Sang-il Kim, Yongin-si (KR); Jae-hoon Kim, Yongin-si (KR)

Correspondence Address: MACPHERSON KWOK CHEN & HEID LLP, 2033 GATEWAY PLACE, SUITE 400, SAN JOSE, CA, 95110, US

(73) Assignees: Samsung Electronics Co., Ltd.; Industry-University Cooperation Foundation, Hanyang University

(21) Appl. No.: 12/156,056

(22) Filed: May 28, 2008

(30) Foreign Application Priority Data
Jul. 20, 2007 (KR) 10-2007-0073080

(51) Int. Cl. C08L 5/12; B32B 27/00; C09K 19/00; B32B 7/14

(52) U.S. Cl. 428/1.5; 524/27; 428/532; 156/326

(57) ABSTRACT

An adhesion composition is disclosed. In one embodiment, the composition includes a gel material and an adhesion resin, a weight ratio of the gel material and the adhesion resin ranging from about 1:10 to about 1:100.

### CROSS-REFERENCE TO RELATED APPLICATIONS

This application claims priority to Korean Patent Application No. 10-2007-0073080, filed on Jul. 20, 2007, in the Korean Intellectual Property Office, the disclosure of which is incorporated herein by reference.

### BACKGROUND OF THE INVENTION

1. Field of the Invention

Apparatuses and methods consistent with the present invention relate to an adhesion composition, a method of making an adhesion composition, a display device, and a method of making a display device.

2. Description of the Related Art

Recently, a cathode ray tube (CRT) has been replaced by a flat panel display such as a liquid crystal display (LCD) device, an organic light emitting diode (OLED), or an electrophoretic display device.

The LCD device includes a first substrate having a thin film transistor, a second substrate facing the first substrate, and a liquid crystal layer interposed between the first and second substrates.

The optical property of the LCD device is closely related to a cell gap; i.e., a distance between the first and second substrates. Particularly, the contrast ratio and viewing angle depend on cell gap multiplied by a birefringence Δn of the liquid crystals. If the cell gap is not consistent, the optical property of the LCD device will not be consistent as well. The cell gap may not be consistent if the LCD device is twisted, particularly in a flexible LCD device.

To maintain the cell gap consistently, a first substrate and a second substrate in a display region are attached to each other by a spacer and an adhesion resin layer.

In the foregoing method, the adhesion resin layer is formed and then the liquid crystal layer is introduced. Then, the adhesion resin layer is cured. However, the adhesion resin layer may run down along lateral sides of the spacer before being cured, thereby disadvantageously contaminating the liquid crystal layer.

### SUMMARY OF THE INVENTION

Accordingly, it is an aspect of the present invention to provide an adhesion composition which has an appropriate strength and is not easily deformed even if uncured, and a making method thereof.

Also, it is another aspect of the present invention to provide a display device which uses an adhesion composition that has an appropriate strength and is not deformed easily even if uncured, and a making method thereof.

Additional aspects and/or advantages of the present invention will be set forth in part in the description which follows and, in part, will be obvious from the description, or may be learned by practice of the present invention.

The foregoing and/or other aspects of the present invention are also achieved by providing an adhesion composition, including: a gel material; and an adhesion resin; a weight ratio of the gel material and the adhesion resin ranging from about 1:10 to about 1:100.

According to an aspect of the invention, the gel material and the adhesion resin are dispersed in water.

According to an aspect of the invention, the gel material includes at least one of agar, agarose, silicagel, hydrogel, xerogel, diatomite, acid clay, and carrageenan.

According to an aspect of the invention, gel strength (1.5 wt %) of the gel material is about 1500 gm/cm² and above, a remelt point (1.5 wt %) of the gel material ranges from about 80° C. to 120° C., and a gel point (1.5 wt %) of the gel material ranges from about 34° C. to 43° C.

According to an aspect of the invention, at least a part of the adhesion resin is surrounded by the gel material.

The foregoing and/or other aspects of the present invention are also achieved by providing a method of making an adhesion composition, the method including: mixing water, a gel material, an uncured adhesion resin and an anticoagulant to provide a dispersion liquid; heating the dispersion liquid to a temperature ranging between the gel point of the gel material+50° C. to the gel point of the gel material+200° C. and above; cooling the heated dispersion liquid to the gel point of the gel material and below; and curing the dispersion liquid with at least one of UV and heat.

According to an aspect of the invention, the gel material includes at least one of agar, agarose, silicagel, hydrogel, xerogel, diatomite, acid clay, and carrageenan.

The foregoing and/or other aspects of the present invention are also achieved by providing a display device, including: a first substrate which includes a spacer; a second substrate which faces the first substrate; and an adhesion layer which is formed between the second substrate and the spacer, adheres the first and second substrates to each other, and includes a gel material and an adhesion resin.

According to an aspect of the invention, the display device further includes a liquid crystal layer which is disposed between the first and second substrates.

According to an aspect of the invention, the gel material includes at least one of agar, agarose, silicagel, hydrogel, xerogel, diatomite, acid clay, and carrageenan.

According to an aspect of the invention, the adhesion resin includes at least one of epoxy resin and acrylic resin, and a weight ratio of the gel material and the adhesion resin ranges from about 1:10 to about 1:100.

According to an aspect of the invention, the adhesion layer further includes an anticoagulant.

According to an aspect of the invention, the anticoagulant includes at least one of ethylenediamine-tetraacetic (EDTA), heparin, double oxalate, sodium citrate, sodium fluoride, sodium oxalate, acid citrate dextrose (ACD), and hirudin.

According to an aspect of the invention, the gel material of the adhesion layer is scattered in the adhesion resin.

According to an aspect of the invention, a gel strength (1.5 wt %) of the gel material is about 1500 gm/cm² and above, a remelt point (1.5 wt %) of the gel material is about 80° C. to 120° C., and a gel point (1.5 wt %) of the gel material ranges from about 34° C. to 43° C.

According to an aspect of the invention, at least one of the first and second substrates includes a plastic substrate.

According to an aspect of the invention, the spacer is scattered.

According to an aspect of the invention, the spacer is formed in a grid pattern.

According to an aspect of the invention, the first substrate includes a first alignment layer, the second substrate includes a second alignment layer, and the liquid crystal layer substantially contacts the first and second alignment layers excluding the spacer.

The foregoing and/or other aspects of the present invention are also achieved by providing a method of making a display device, the making method including: providing a first substrate which has a spacer on a first surface; forming an adhesion composition layer including a gel material and an uncured adhesion resin on the spacer; applying liquid crystals to the first surface of the first substrate after the adhesion composition layer is formed; arranging a second substrate on the adhesion composition layer; and curing the uncured adhesion resin while the adhesion composition layer contacts the second substrate.

According to an aspect of the invention, forming the adhesion composition layer includes providing a dispersion liquid by mixing water, a gel material, an uncured adhesion resin and an anticoagulant, heating the dispersion liquid to gel point of the gel material+50° C. to gel point of the gel material+200° C. and above, cooling the dispersion liquid to the gel point of the gel material and below to provide an adhesion composition, and applying the adhesion composition to the spacer.

According to an aspect of the invention, applying the adhesion composition to the spacer includes providing an adhesion substrate coated with the adhesion composition, and contacting the first substrate with the adhesion substrate while the spacer faces the adhesion composition.

According to an aspect of the invention, at least one of the first substrate and the adhesion substrate is rolled up to contact each other.

According to an aspect of the invention, the providing the first substrate includes forming a first alignment layer on the spacer and the first surface.

According to an aspect of the invention, the second substrate includes a second alignment layer which contacts the adhesion composition layer directly.

According to an aspect of the invention, the gel material includes at least one of agar, agarose, silicagel, hydrogel, xerogel, diatomite, acid clay, and carrageenan.

According to an aspect of the invention, the anticoagulant includes at least one of ethylenediamine-tetraacetic (EDTA), heparin, double oxalate, sodium citrate, sodium fluoride, sodium oxalate, acid citrate dextrose (ACD), and hirudin.

### BRIEF DESCRIPTION OF THE DRAWINGS

The above and/or other aspects of the present invention will become apparent and more readily appreciated from the following description of the embodiments, taken in conjunction with the accompanying drawings of which:

FIG. 1 is an exploded perspective view of a liquid crystal display device according to a first embodiment of the present invention;

FIG. 2 is a sectional view of the liquid crystal display device, taken along a line II-II in FIG. 1;

FIG. 3 is an enlarged view of a part A in FIG. 2;

FIG. 4 is a flowchart to describe a method of making the liquid crystal display device according to the first embodiment of the present invention;

FIGS. 5A to 9 illustrate the method of making the liquid crystal display device according to the first embodiment of the present invention;

FIG. 10 illustrates a method of forming an adhesion composition layer on a spacer according to an embodiment of the present invention;

FIG. 11 is a perspective view of another spacer used in the present invention; and

FIG. 12 is a sectional view of a liquid crystal display device according to a second embodiment of the present invention.

### DETAILED DESCRIPTION

Hereinafter, embodiments of the present invention will be described with reference to accompanying drawings, wherein like numerals refer to like elements and repetitive descriptions will be avoided as necessary.

Hereinafter, forming a film (i.e., a layer) “on” another film (i.e., a layer) means that a third layer is disposed or not disposed between the two films (i.e., layers), and forming a film (i.e., a layer) “right on” or “directly on” another film (i.e., a layer) means that the two films (i.e., layers) contact each other.

Hereinafter, a liquid crystal display (LCD) device is an example of a display device, but not limited thereto. The present invention may be applicable to other display devices such as an organic light emitting diode (OLED) or an electrophoretic display device.

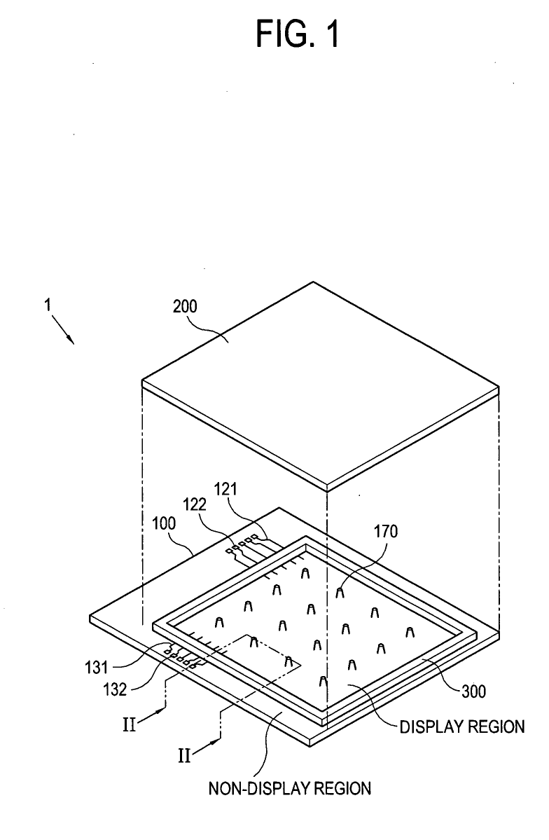

A liquid crystal display device according to a first embodiment of the present invention will be described with reference to FIGS. 1 to 3.

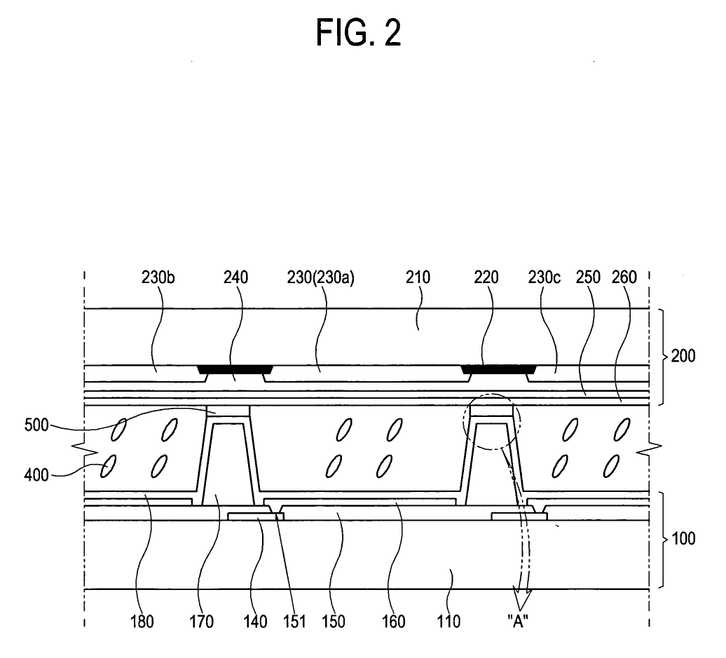

As shown in FIG. 1, a liquid crystal display device 1 includes a first substrate 100, a second substrate 200, and a sealant 300. FIG. 1 does not illustrate a liquid crystal layer 400 and an adhesion layer 500 (refer to FIG. 2) for convenience.

The first substrate 100 is larger than the second substrate 200. The internal part of the sealant 300 corresponds to a display region while the external part corresponds to a non-display region. The first substrate 100 includes a gate line 121 extending to the display region, a gate pad 122 connected with the gate line 121 and disposed in the non-display region, a data line 131 extending to the display region, and a data pad 132 connected with the data line 131 and disposed in the non-display region.

The gate line 121 and the data line 131 are connected with a thin film transistor (TFT) 140 (refer to FIG. 2). The gate line 121 supplies a gate signal (gate-on voltage and gate-off voltage) to the thin film transistor 140 while the data line 131 supplies a data voltage to the thin film transistor 140.

The gate pad 122 and the data pad 132 receive a gate signal and a data voltage, respectively, from outside the display region.

According to another embodiment, the gate pad 122 may be omitted.

A spacer 170 is formed in the display region of the first substrate 100. The spacer 170 maintains a cell gap, i.e. a distance between the first and second substrates 100 and 200 consistently, together with the sealant 300. The spacer 170 may include a photoresist material.

The spacer 170 is shaped like a cylinder, and scattered in the display region, in one example.

The sealant 300 adheres the first and second substrates 100 and 200 to one another, and surrounds the liquid crystal layer 400 together with the first and second substrates 100 and 200. The sealant 300 is formed in the non-display region along a circumference of the display region, and includes UV curing resin such as acrylic resin. The sealant 300 may further include epoxy resin (e.g., a heat-cured resin), an amine hardener, and a filler such as alumina powder.

Referring to FIG. 2, the liquid crystal display device 1 according to the first embodiment will be described in more detail.

The thin film transistor 140 is formed on a first insulating substrate 110 of the first substrate 100. The thin film transistor 140 is connected with the gate line 121 and the data line 131.

An insulating layer 150 is formed on the thin film transistor 140. A contact hole 151 is formed in the insulating layer 150 to expose the thin film transistor 140 therethrough.

A pixel electrode 160 and the spacer 170 are formed on the insulating layer 150.

The pixel electrode 160 may be made of a transparent conductive material, such as indium tin oxide (ITO) or indium zinc oxide (IZO) in one example. The pixel electrode 160 is connected with the thin film transistor 140 through the contact hole 151.

In one example, the spacer 170 may be formed by coating, exposing and developing a photoresist layer. The spacer 170 is formed on the thin film transistor 140 so as not to reduce an aperture ratio. According to another embodiment, the spacer 170 may be formed on the gate line 121 or the data line 141.

A first alignment layer 180 is formed on the pixel electrode 160 and the spacer 170. The first alignment layer 180 includes polyimide, silicon dioxide, etc.

A black matrix 220 is formed on a second insulating layer 210 of the second substrate 200.

The black matrix 220 is formed in a grid pattern, and prevents external light from being supplied to a channel region of the thin film transistor 140. The black matrix 220 may include chromium oxide or an organic material including a black pigment in one example.

A color filter 230 is formed between the black matrixes 220. The color filter 230 is regularly formed, and includes three sub layers 230a, 230b and 230c which are repeatedly formed and have different colors.

An overcoat layer 240 is formed on the color filter 230. The overcoat layer 240 provides a planar surface and protects the color filter 230.

A common electrode 250 is formed on the overcoat layer 240. The common electrode 250 includes a transparent conductive material such as indium tin oxide (ITO) or indium zinc oxide (IZO) in one example. The common electrode 250 supplies a voltage to the liquid crystal layer 400 together with the pixel electrode 160 to adjust an alignment of the liquid crystal layer 400.

A second alignment layer 260 is formed on the common electrode 250. The second alignment layer 260 includes polyimide, silicon dioxide, etc.

The first and second insulating layers 110 and 210 include glass, quartz or plastic in one example. If the first and second insulating layers 110 and 210 include plastic, the liquid crystal display device 1 is flexible. Then, it is difficult to maintain the cell gap consistently.

The plastic material may include polycarbonate, polyimide, polyesthersulphone (PES), polyacrylate (PAR), polyethylenenaphthalate (PEN), and/or polyethyleneterephthalate (PET), but is not limited thereto.

The liquid crystal layer 400 is disposed in a space formed by the first and second substrates 100 and 200 and the sealant 300. The liquid crystal layer 400 is aligned in a particular direction by the first and second alignment layers 180 and 260. The alignment of the liquid crystal layer 400 is changed by a voltage difference between the pixel electrode 160 and the common electrode 250.

The adhesion layer 500 is disposed between the first and second substrates 100 and 200, and adheres the first and second substrates 100 and 200 to each other. More specifically, the adhesion layer 500 connects the first alignment layer 180 of the first substrate 100 and the second alignment layer 260 of the second substrate 200.

The adhesion layer 500 is disposed on an interfacing surface of the spacer 170 (e.g., a planar top surface), and is rarely on lateral sides of the spacer 170. That is, the adhesion layer 500 barely exists in an area of the pixel electrode 160. Thus, the adhesion layer 500 does not interrupt the contact between the liquid crystal layer 400 and the first and second alignment layers 180 and 260. The alignment of the liquid crystal layer 400 is determined by both of the first and second alignment layers 180 and 260.

The first and second substrates 100 and 200 are connected with each other by the adhesion layer 500 across the display region. Thus, the distance between the first and second substrates 100 and 200 is maintained consistently even if the liquid crystal display device 1 is twisted.

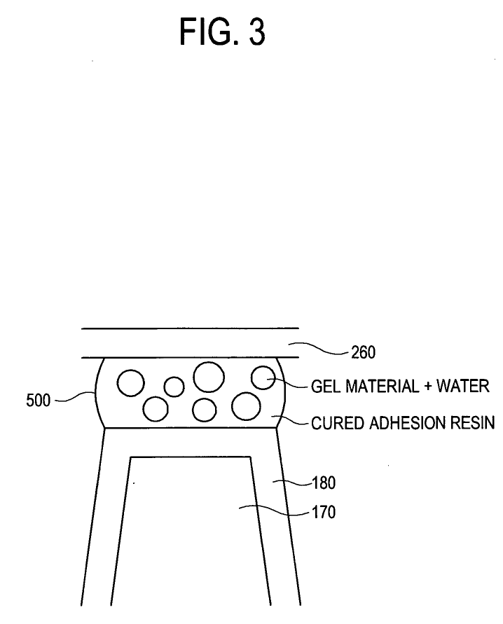

Referring now to FIG. 3, the adhesion layer 500 will be described in more detail.

The adhesion layer 500 includes water, a gel material and cured adhesion resin. The cured adhesion resin is provided by curing uncured adhesion resin with UV light and/or heat. The adhesion layer 500 may further include an anticoagulant. The gel material is included in water and scattered in the cured adhesion resin. That is, the cured adhesion resin is in a continuous phase. According to another embodiment, the gel material included in the water may be mixed with the cured adhesion resin.

The gel material assigns an appropriate strength to the adhesion layer 500 before the uncured adhesion resin is cured. The cured adhesion resin adheres the first and second substrates 100 and 200 to each other.

The weight ratio of the gel material and the cured adhesion resin may range from about 1:10 to about 1:100 in one example. If the weight ratio of the gel material and the cured adhesion resin is lower than about 1:10 (that is, if the content of the cured adhesion resin is small), the adhesive strength is reduced. If the adhesive strength is reduced and if the liquid crystal display device 1 is twisted, the adhesion layer 500 may be separated from one of the first and second substrates 100 and 200. Meanwhile, if the weight ratio of the gel material and the cured adhesion resin is higher than about 1:100 (i.e., if the content of the gel material is small), the strength of the adhesion layer 500 becomes weaker while being formed, and may run down or flow over a lateral side surface of spacer 170. The run-down uncured adhesion resin may contaminate the liquid crystal layer 400.

The weight ratio of the gel material and the water may be about 1:40 to about 1:200 in one example. The specific weight ratio is determined considering the remelt point and the gel strength of the gel material.

The gel material may include agar, agarose, i.e. main component of agar, silicagel, hydrogel, xerogel, diatomite, acid clay, carrageenan, etc.

The cured adhesion resin may include heat-curing resin or UV curing resin, but is not limited thereto. The cured adhesion resin may include epoxy resin or acrylic resin in one example.

The anticoagulant may include ethylenediamine-tetraacetic (EDTA), heparin, double oxalate, sodium citrate, sodium fluoride, sodium oxalate, acid citrate dextrose, and/or hirudine. The anticoagulant may include both EDTA and sodium fluoride, or both EDTA and formalin.

The weight ratio of the gel material and the anticoagulant may be about 1:0.05 to about 1:2 in one example.

The component of the gel material, the cured adhesion resin, and the anticoagulant may vary depending on the type of materials used.

If the anticoagulant includes EDTA, the adhesion layer 500 may further include a basic material such as NaOH.

The role of the foregoing gel material, cured adhesion resin, anticoagulant, and basic material will be described later in more detail.

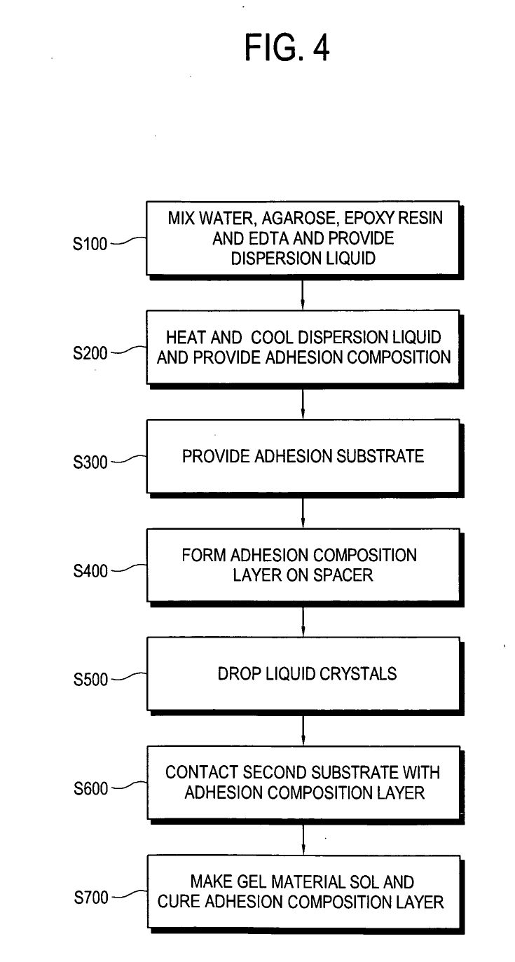

Hereinafter, a method of making the liquid crystal display device 1 according to the first embodiment of the present invention will be described with reference to FIGS. 4 to 10.

In the following explanation, the gel material includes agarose, the uncured adhesion resin includes epoxy resin, and the anticoagulant includes EDTA. Here, agarose is included in water.

Agarose is the main component of agar. The gel point and the remelt point of agarose depend on the degree of purity. Agarose is classified into standard agarose, high-gel-strength agarose, low melting/gel point agarose, low-viscosity and low melting/gel point agarose.

If agarose is heated and then cooled, it is changed to gel from sol. The gel point refers to a temperature from which heated agarose becomes gel.

If the agarose gel is reheated, it becomes sol again. The remelt point refers to a temperature at which the agarose is changed from gel to sol.

The present invention uses the property of agarose which is changed from the hard gel to relatively soft sol.

Hereinafter, wt % with respect to the gel point, remelt point and gel strength refers to wt % of the gel material with respect to water.

The gel point of 1.5 wt % high-gel-strength agarose is about 34° C. to 43° C., and the remelt point is about 85° C. to 95° C. The high-gel-strength agarose includes chromosomal grade agarose from Bio-Rad, Fastlane and Seakem gold from BioWhittaker, in one example.

The agarose according to the present embodiment includes chromosomal grade agarose from Bio-Rad. The gel point of 1.5 wt % chromosomal grade agarose is approximately 38° C., and the remelt point of 1.5 wt % chromosomal grade agarose is approximately 85° C. to 95° C. The gel strength of 1.5 wt % chromosomal grade agarose is approximately 3000 gm/cm³ and above.

The remelt point of 1.5 wt % agarose may range from about 80° C. to 120° C. If the remelt point is too low, agarose becomes sol while in process, and the uncured adhesion resin may run down. Meanwhile, if the remelt point is too high, the temperature rises to change agarose from gel to sol.

The gel strength refers to a strength to fracture the agarose gel. The gel strength of 1.5 wt % agarose may be about 1500 gm/cm² and above. If the gel strength is too low, the adhesion layer 500 may run down or be deformed while in process before being cured.

Epoxy resin (i.e., the uncured adhesion resin) includes a monomer or an oligomer including an epoxy group. The epoxy resin may include a polymer having an epoxy group.

As shown in FIG. 4, a dispersion liquid is made through mixing water (distilled water), agarose, the uncured epoxy resin and EDTA (S100). EDTA is melted by basic water. Thus, the dispersion liquid includes a small amount of a base, such as NaOH, to have pH 8 and above.

Agarose is hydrophilic and is easily mixed with water while the uncured epoxy resin is hydrophobic and is not easily mixed with water. EDTA is added to the dispersion liquid to make the uncured epoxy resin dispersed and become a polymer colloid.

If EDTA is not added, the uncured epoxy resin is condensed immediately. If the content of EDTA is not sufficient, the uncured epoxy resin is condensed in a few minutes or an hour to make the process difficult. Fifty to 80 wt % water, 25 to 45 wt % uncured epoxy resin, and 0.2 to 2 wt % EDTA may be used to make the dispersion liquid. The weight ratio of agarose and water may range from about 1:40 to about 1:200. More specifically, 65.1 to 66.2 wt % water, 33 wt % uncured epoxy resin, 0.67 to 1.33 wt % agarose, and 0.45 to 0.67 wt % EDTA may be used.

Then, the dispersion liquid is heated and cooled to provide an adhesion composition (S200). The dispersion liquid is heated to a temperature between about gel point plus 50° C. and about gel point plus 200° C. (i.e., between about 50° C. and about 200° C. above the gel point). The dispersion liquid is cooled below the gel point. The gel point varies depending on the content of agarose, more specifically depending on the content of agarose with respect to water.

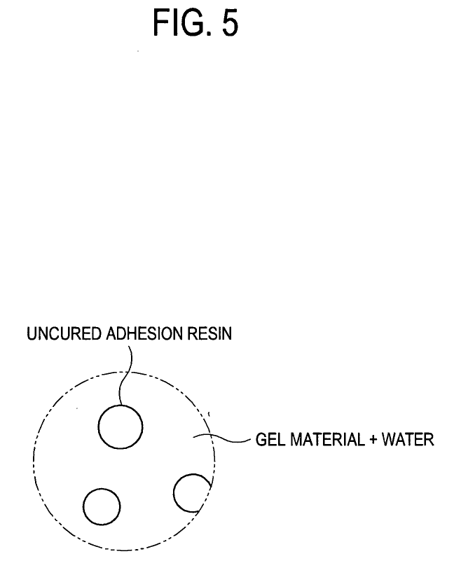

Agarose becomes hard gel by being heated and cooled. As shown in FIG. 5, the uncured epoxy resin (uncured adhesion resin) is surrounded by agarose (gel material) included in water.

If the heating temperature of the dispersion liquid is lower than gel point plus 50° C., the uncured epoxy resin is not surrounded by agarose. Then, the uncured epoxy resin of the adhesion layer 500 may run down in the subsequent process. Meanwhile, if the heating temperature of the dispersion liquid is higher than gel point plus 200° C., agarose and the uncured epoxy resin may be deformed. Then, the uncured epoxy resin may run down to the pixel region.

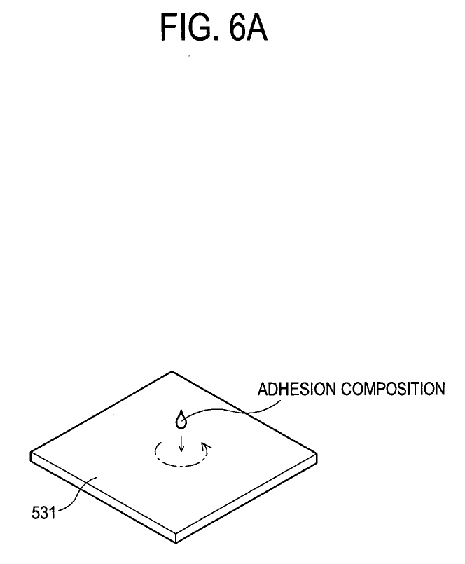

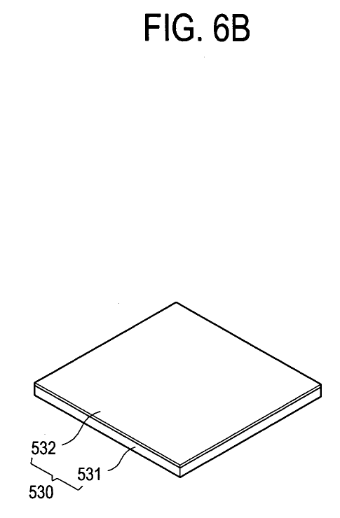

As shown in FIGS. 6A and 6B, an adhesion substrate 530 is provided (S300). To provide the adhesion substrate 530, the adhesion composition is dropped to a substrate 531 (e.g., including glass or plastic), and the substrate 531 is rotated (e.g., a spin coating method is used), as shown by the curved arrow in FIG. 6A. FIG. 6B illustrates a completed adhesion substrate 530 on which an adhesion composition layer 532 is formed.

The strength of the adhesion composition layer 532 grows if the content of agarose increases. Thus, if the content of agarose is high, weak gel strength of agarose does not matter.

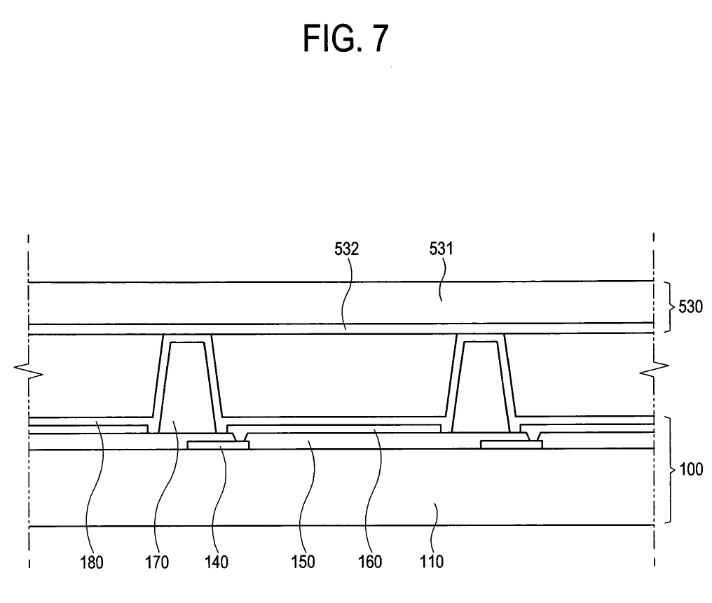

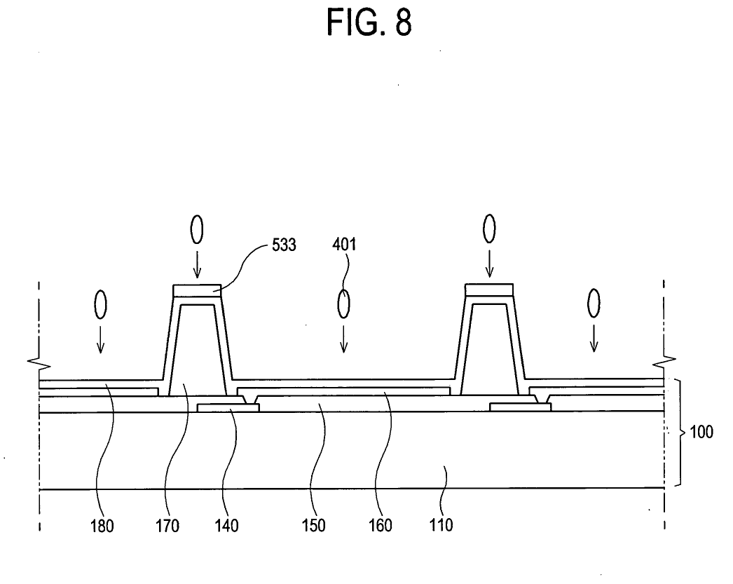

As shown in FIGS. 7 and 8, the adhesion composition layer 532 is formed on the spacer 170 of the first substrate 100 (S400). The first substrate 100 may be provided by a known art, and the detailed making method thereof will be avoided here.

The adhesion composition layer 532 of the adhesion substrate 530 is transferred to the spacer 170 of the first substrate 100 by contact and press in one embodiment. As shown in FIG. 7, the adhesion substrate 530 is arranged on the first substrate 100 and then pressed thereto. In this case, the adhesion composition layer 532 of the adhesion substrate 530 faces the spacer 170. The adhesion composition layer 532 of the adhesion substrate 530 is formed on the first alignment layer 180 of the spacer 170 by press.

The adhesion composition layer 533 (FIG. 8) formed on the spacer 170 from adhesion substrate 530 has an appropriate strength due to the hard agarose gel. Thus, the adhesion composition layer 533 is neither deformed nor run down.

As shown in FIG. 8, a liquid crystal 401 is dropped to the first substrate 100 (S500). In the adhesion composition layer 533, the uncured epoxy resin is surrounded by agarose (gel material) included in water. Thus, the epoxy resin and the liquid crystal 401 are less mixed and contaminated.

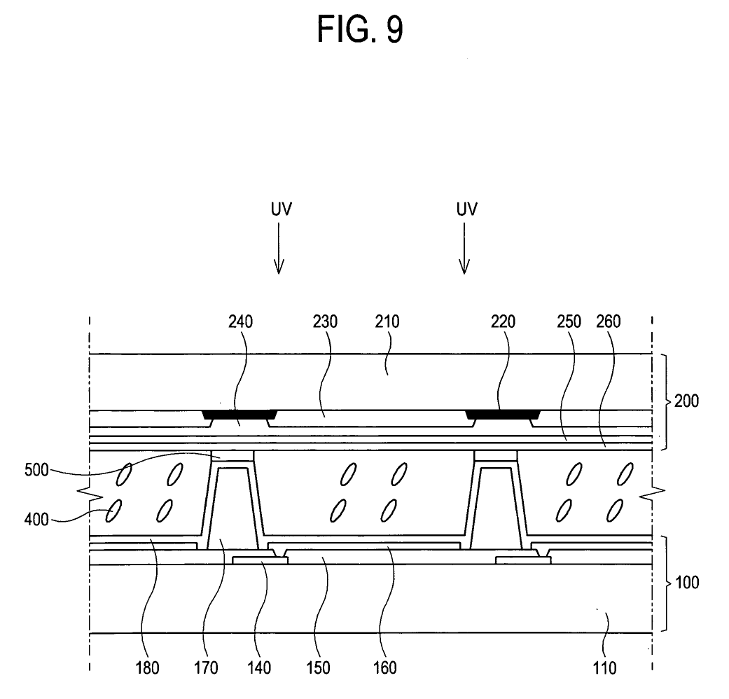

As shown in FIG. 9, the second substrate 200 is arranged to contact the adhesion composition layer 533 (S600). UV is applied to the adhesion composition layer 533 to cure the adhesion composition layer 533 (S700). Then, the adhesion composition layer 533 becomes the adhesion layer 500, and the sealant 300 is also cured by UV. The second substrate 200 may be manufactured by a known art, and the manufacturing method thereof will be avoided here.

The adhesion composition layer 533 has an appropriate strength due to the gel material, and does not run down along the lateral sides of the spacer 170 even if contacting the second substrate 200 and being pressed.

The adhesion composition layer 533 is cured after the agarose gel is heated to become sol. That is, the adhesion composition layer 533 is cured at the remelt point and above the remelt point of agarose. The remelt point of agarose may vary depending on the content of agarose, more specifically depending on the content of agarose with respect to water.

If agarose becomes sol and soft, the uncured epoxy resin flows out from the inside of agarose to the outside. The flowed uncured epoxy resin contacts the first and second alignment layers 180 and 260. If the temperature of the adhesion composition layer 533 is raised too much, the strength of the adhesion composition layer 533 is lowered and the adhesion composition layer may run down.

Then, UV is applied to the adhesion composition layer 533 to cure the uncured epoxy resin, thereby forming the adhesion layer 500 adhering the first and second substrates 100 and 200 as shown in FIG. 9.

As described above, the adhesion layer 500 according to the present invention is formed by curing the adhesion composition layer 533 including the gel material and the uncured adhesion resin. As agarose gel is hard and has an appropriate strength, the adhesion composition layer 533 does not easily run down. Thus, the adhesion composition layer 533 does not contaminate the liquid crystal 401.

If the adhesion composition layer 533 is cured, agarose becomes sol and the uncured epoxy resin is cured to contact the first and second substrates 100 and 200. Then, the first and second substrates 100 and 200 are adhered to each other by UV.

As the adhesion layer 500 is mainly disposed on the spacer 170, the liquid crystal layer 400 contacts both the first and second alignment layers 180 and 260. According to the present invention, the cell gap changes may be prevented in case of providing the alignment layer on the two substrates, as well as in case of providing the alignment layer on one of the two substrates.

According to the present embodiment, the liquid crystal 401 is formed by a dropping method, but not limited thereto. Alternatively, the liquid crystal 401 may be formed by a filling method.

According to another embodiment, the spacer 170 may be formed on the second substrate 200 instead of on the first substrate 100. If the uncured adhesion resin includes heat-curing adhesion resin, the adhesion composition layer 533 may be cured by heat.

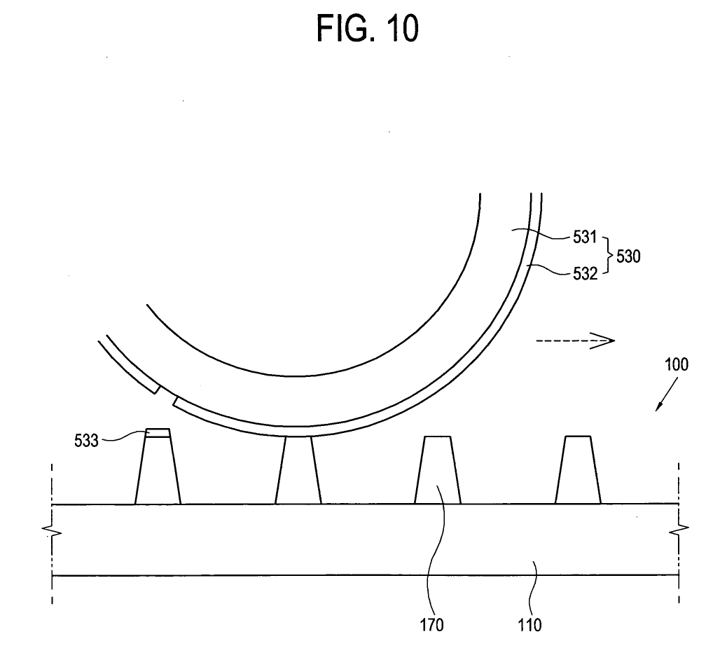

FIG. 10 illustrates another method of making the liquid crystal display device in accordance with the present invention. FIG. 10 corresponds to a step shown in FIG. 7 and illustrates a method of forming the adhesion composition layer 533 on the spacer 170.

The adhesion substrate 530 is rolled up and covered with the adhesion composition layer 532, and rotates on the first substrate 100. The adhesion substrate 530 contacts the first substrate 100 while rotating, and the adhesion composition layer 532 of the adhesion substrate 530 is transferred to the spacer 170 to form adhesion composition layer 533.

According to another embodiment, the first substrate 100 may be rolled up to form the adhesion composition layer 533 thereon.

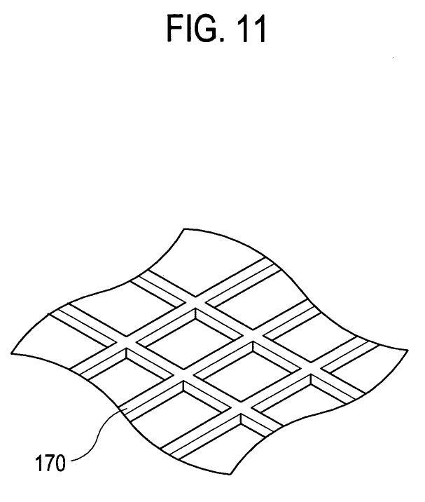

FIG. 11 illustrates another spacer 170 which is used in the present invention.

The spacer 170 is formed as a wall, and the liquid crystal layer 400 is surrounded by the spacer 170 and does not move freely. The spacer 170 in FIG. 11 adheres the first and second substrates 100 and 200 to each other more firmly by providing a greater surface area of an adhesion layer on the interfacing surfaces of the spacer 170.

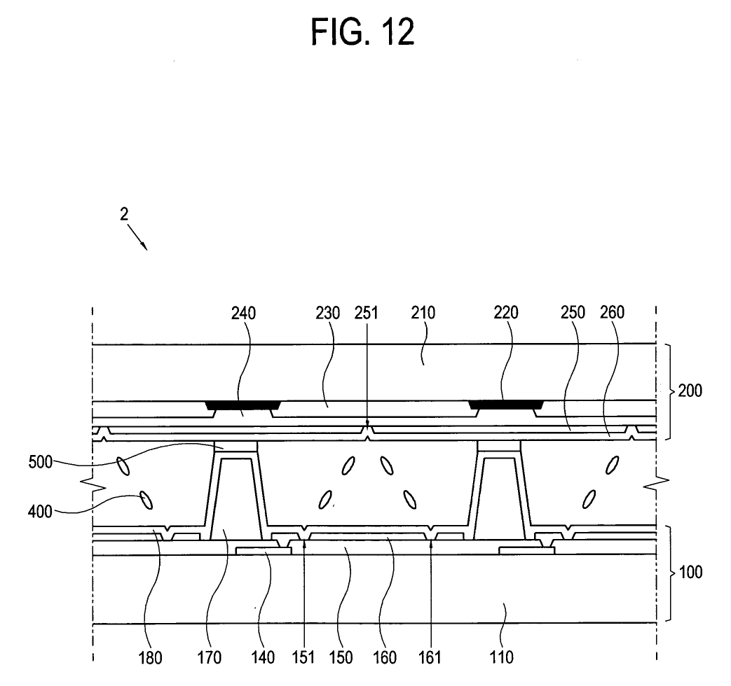

Referring to FIG. 12, a liquid crystal display device 2 according to a second embodiment of the present invention will be described.

A pixel electrode cutting pattern 161 is formed in a pixel electrode 160 while a common electrode cutting pattern 251 is formed in a common electrode 250. The liquid crystal molecule of a liquid crystal layer 400 has negative dielectric anisotropy. A longer axis of the liquid crystal molecule is vertically aligned to an electric field.

First and second alignment layers 180 and 260 are vertical alignment layers, and the longer axis of the liquid crystal molecule is vertically aligned to first and second substrates 100 and 200 while the electric field is not formed. The liquid crystal layer 400 contacts both the first and second alignment layers 180 and 260, and is initially aligned without difficulty.

If the electric field is formed between the pixel electrode 160 and the common electrode 250, the longer axis of the liquid crystal molecule is horizontally aligned to adjust transmissivity. The pixel electrode cutting pattern 161 and the common electrode cutting pattern 251 form a fringe field to divide the liquid crystal layer 400 into a plurality of domains. The lying direction of the liquid crystal layer 400 disposed in the respective domains is determined by the fringe field.

Then, a plurality of domains having different lying directions of the liquid crystal layer 400 is formed in a single pixel, thereby improving a viewing angle.

According to another embodiment, a projection may be used instead of the cutting patterns 161 and 251. The present invention may be applicable to make a liquid crystal display device in which the pixel electrode and the common electrode are formed on the same substrate.

As described above, the present invention provides an adhesion composition which has an appropriate strength and is not easily deformed even if uncured, and a making method thereof.

Also, the present invention provides a display device which uses an adhesion composition having an appropriate strength and is not easily deformed even if uncured, and a making method thereof.

Although embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. An adhesion composition, comprising:
a gel material; and
an adhesion resin;
a weight ratio of the gel material and the adhesion resin ranging from about 1:10 to about 1:100.

2. The adhesion composition according to claim 1, wherein the gel material and the adhesion resin are dispersed in water.

3. The adhesion composition according to claim 1, wherein the gel material comprises at least one of agar, agarose, silicagel, hydrogel, xerogel, diatomite, acid clay, or carrageenan.

4. The adhesion composition according to claim 1, wherein gel strength (1.5 wt %) of the gel material is 1500 gm/cm² and above, a remelt point (1.5 wt %) of the gel material ranges from 80° C. to 120° C., and a gel point (1.5 wt %) of the gel material ranges from 34° C. to 43° C.

5. The adhesion composition according to claim 1, wherein at least a part of the adhesion resin is surrounded by the gel material.

6. A display device, comprising:
a first substrate including a spacer;
a second substrate facing the first substrate; and
an adhesion layer formed between the second substrate and the spacer, the adhesion layer coupling the first and second substrates to each other and comprising a gel material and an adhesion resin.

7. The display device according to claim 6, further comprising a liquid crystal layer which is disposed between the first and second substrates.

8. The display device according to claim 6, wherein the gel material comprises at least one of agar, agarose, silicagel, hydrogel, xerogel, diatomite, acid clay, or carrageenan.

9. The display device according to claim 6, wherein the adhesion resin comprises at least one of epoxy resin and acrylic resin, and a weight ratio of the gel material and the adhesion resin ranges from about 1:10 to about 1:100.

10. The display device according to claim 6, wherein the adhesion layer further comprises an anticoagulant.

11. The display device according to claim 10, wherein the anticoagulant comprises at least one of ethylenediamine-tetraacetic (EDTA), heparin, double oxalate, sodium citrate, sodium fluoride, sodium oxalate, acid citrate dextrose (ACD), or hirudin.

12. The display device according to claim 6, wherein the gel material of the adhesion layer is scattered in the adhesion resin.

13. The display device according to claim 6, wherein a gel strength (1.5 wt %) of the gel material is 1500 gm/cm² and above, a remelt point (1.5 wt %) of the gel material ranges from 80° C. to 120° C., and a gel point (1.5 wt %) of the gel material ranges from 34° C. to 43° C.

14. The display device according to claim 6, wherein at least one of the first and second substrates comprises a plastic substrate.

15. The display device according to claim 6, wherein the spacer is scattered.

16. The display device according to claim 6, wherein the spacer is formed in a grid pattern.

17. The display device according to claim 7, wherein the first substrate comprises a first alignment layer,
the second substrate comprises a second alignment layer, and
the liquid crystal layer substantially contacts the first and second alignment layers excluding the spacer.

18. A method of making a display device, the method comprising:
providing a first substrate including a spacer on a first surface;
forming an adhesion composition layer on the spacer, the adhesion composition layer including a gel material and an uncured adhesion resin;
applying liquid crystals to the first surface of the first substrate after the adhesion composition layer is formed;
arranging a second substrate on the adhesion composition layer; and
curing the uncured adhesion resin while the adhesion composition layer contacts the second substrate.

19. The method according to claim 18, wherein forming the adhesion composition layer comprises:
providing a dispersion liquid by mixing water, a gel material, an uncured adhesion resin, and an anticoagulant;
heating the dispersion liquid to a temperature between 50° C. and 200° C. above a gel point of the gel material;
cooling the dispersion liquid to the gel point of the gel material and below thereby providing an adhesion composition; and
applying the adhesion composition to the spacer.

20. The method according to claim 19, wherein applying the adhesion composition to the spacer comprises providing an adhesion substrate coated with the adhesion composition, and contacting the first substrate with the adhesion substrate while the spacer faces the adhesion composition.

21. The method according to claim 20, wherein at least one of the first substrate and the adhesion substrate is rolled up to contact each other.

22. The method according to claim 18, wherein providing the first substrate comprises forming a first alignment layer on the spacer and the first surface.

23. The method according to claim 18, wherein the second substrate comprises a second alignment layer which directly contacts the adhesion composition layer.

24. The method according to claim 18, wherein the gel material comprises at least one of agar, agarose, silicagel, hydrogel, xerogel, diatomite, acid clay, and carrageenan.

25. The method according to claim 18, wherein the anticoagulant comprises at least one of ethylenediamine-tetraacetic (EDTA), heparin, double oxalate, sodium citrate, sodium fluoride, sodium oxalate, acid citrate dextrose (ACD), and hirudin.
